(19) United States
(12) Patent Application Publication
(10) Pub. No.: US 2023/0328651 A1
(43) Pub. Date: Oct. 12, 2023

(54) BI-MODAL CELLULAR DEVICE

(71) Applicant: Appareo Systems, LLC, Fargo, ND (US)

(72) Inventors: Josh Gelinske, Fargo, ND (US); David Batcheller, Fargo, ND (US); Ross Eickhoff, Harwood, ND (US); Jameson Bickert, Berthoud, CO (US); Christopher William Horne, Fargo, ND (US)

(73) Assignee: Appareo Systems, LLC, Fargo, ND (US)

(21) Appl. No.: 18/133,590

(22) Filed: Apr. 12, 2023

Related U.S. Application Data
(60) Provisional application No. 63/330,074, filed on Apr. 12, 2022.

(51) Int. Cl. H04W 52/02

(52) U.S. Cl. CPC H04W 52/0235; H04W 52/0212; H04W 88/06

(57) ABSTRACT

A bi-modal cellular device installable on remote equipment, the bi-modal cellular device comprising a processor, a high throughput modem, a low power modem, and an antenna. The processor receives, over a network, a signal representative of a request to awaken. The high throughput modem offloads data from the remote equipment in a high throughput mode when the remote equipment is in use. The low power modem offloads data from the remote equipment in a low power mode when the remote equipment is un-powered. The antenna is communicatively coupled to the high throughput modem and the low power modem and configured to transmit the data over the network. The processor is configured to switch between the high throughput modem and the low power modem so that only one of the high throughput modem and the low power modem can offload data over the network at a time.

### RELATED APPLICATIONS

This application is a regular utility non-provisional application and claims priority benefit, with regard to all common subject matter, of U.S. Provisional Patent Application Ser. No. 63/330,074, entitled “BI-MODAL CELLULAR DEVICE”, filed Apr. 12, 2022. The above-referenced provisional application is hereby incorporated by reference in its entirety.

### BACKGROUND

Vehicles such as tractors, loaders, all-terrain vehicles, road vehicles, marine vessels, aircraft, and other equipment are often used or stored in remote settings. Data from remote equipment is often offloaded during operation. This data may include data that is acquired from a CAN bus, ARINC, sensors, cameras, and high speed vehicle interfaces (e.g. Ethernet, MOST, or BroadR-Reach connections). Offloading this data in quasi-real time or real time requires a high speed and sophisticated cellular link. Additionally, it is often desirable to connect to and/or offload data from remote equipment when the remote equipment is not in use or is parked or stored, particularly for remote equipment having cyclic use.

Remote equipment often have limited standby power or battery capacity—they are not equipped with large batteries that can be used to power a telematic device for long periods of time while remote equipment is not operating and charging the battery. Contacting and retrieving data from the remote equipment is currently not performed without depleting its electrical power.

### SUMMARY

Embodiments of the present invention solve the above-mentioned problems and other related problems and provide a distinct advance in the art of offloading remote equipment data. More particularly, the present invention provides a telematics control unit that utilizes a high throughput modem when the remote equipment is in operation and energy consumption is a minor constraint and a low power modem when the remote equipment is not in use.

The bi-modal cellular telematics control unit broadly comprises a processor, a high throughput modem for when the remote equipment is in operation and energy consumption is a minor constraint, a low power modem for when the remote equipment is not in use, a number of supercapacitors, a subscriber identity module SIM, an antenna, and a switch for toggling between the high throughput modem and the low power modem so that only one of the modems can offload data over a network at a time.

The processor includes a first core capable of running a full operating system and a second core having a real-time operating system (OS) to provide deterministic processing of controller area network (CAN), inertial measurement unit (IMU), and input/output (I/O) control. The dual core approach allows for segregation of processes and additional security measures. The importance of a multicore approach or heterogeneous processors is to physically separate responsibilities between the equipment interface (CAN, physical I/Os, etc. running in the MCU in this case and the “connected” interface WiFi, cellular, etc. connections to the application processor core in this case.

The high throughput modem may be a CAT 1, CAT 4, or greater modem for supporting throughput objectives of higher data rate use cases and is communicatively coupled to the processor. The high throughput modem has advantageous speed and bandwidth to allow for data offload in real time. On the other hand, power consumption of the high throughput modem may require the remote equipment to be in use.

The low power modem (e.g., low-power wide area, LPWA module) supports lower power objectives and use cases for wake on cellular features and is communicatively coupled to the processor. LPWA can be any low power variance such as CAT M1, CAT M2, NB1, or NB2. The low power modem may support 3GPP Rel13 features of extended Discontinuous Reception (eDRX) and Power Saving Mode (PSM). The low power modem is configured to offload data from the remote equipment in a low power mode particularly when the remote equipment is un-powered.

The supercapacitors provide supplementary or emergency power to the bi-modal cellular telematics control unit to compensate for power outage events, theft events, disconnection events, and the like. Additional supercapacitors may be used to increase operation time for this state.

The SIM is linked to the high throughput modem and the low power modem via a SIM switch/multiplexer. Alternatively, dual SIMs (one for each modem) may be used depending on constraints of the cellular network carrier.

The antenna is communicatively connected to the high throughput modem and the low power modem via the switch. The antenna is configured to transmit data and receive signals transmitted to the bi-modal cellular telematics control unit over the network.

The switch is communicatively connected between the antenna and the high throughput modem and between the antenna the low power modem and the processor. The switch allows the antenna to be used for both modems and ensures only one of the high throughput modem and low power modem can offload data over the network at a time.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is an environmental diagram of a TCU constructed in accordance with an embodiment of the invention;

FIG. 2 is a schematic diagram of the TCU of FIG. 1; and

FIG. 3 is a flow diagram depicting certain steps of a method of waking up the TCU of FIG. 1.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

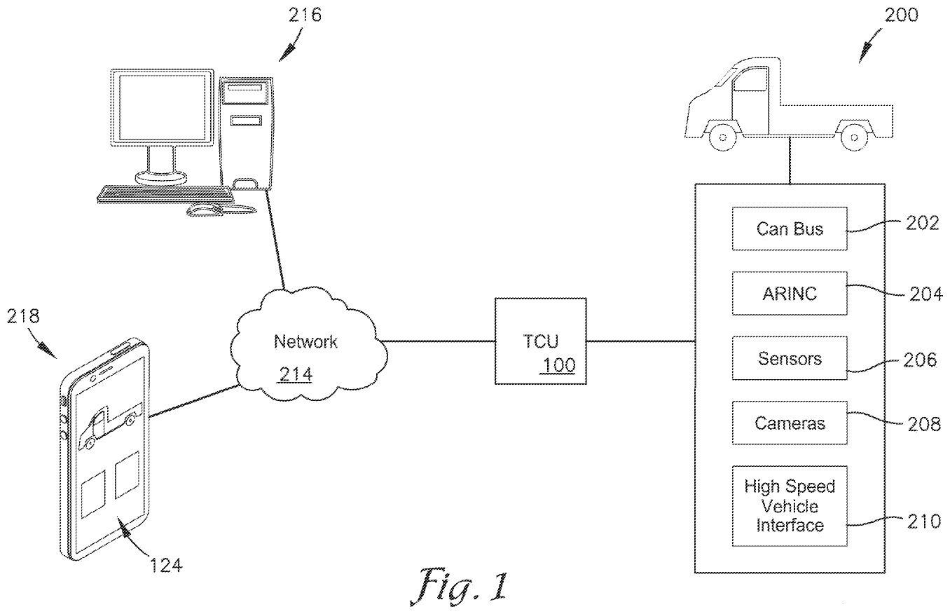

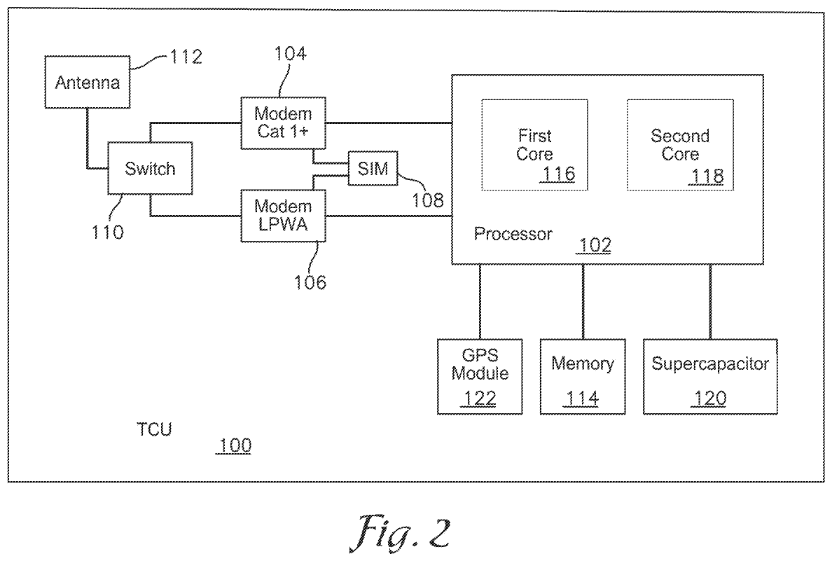

Turning to FIGS. 1 and 2, a bi-modal cellular telematics control unit 100 constructed in accordance with an embodiment of the invention is illustrated. The bi-modal cellular telematics control unit 100 can be installed on remote equipment 200. The remote equipment 200 may be tractors, loaders, all-terrain vehicles, road vehicles, marine vessels, aircraft, and other equipment.

The bi-modal cellular telematics control unit 100 broadly comprises a processor 102, a high throughput modem 104 for when the remote equipment 200 is in operation and energy consumption is a minor constraint, a low power modem 106 for when the remote equipment 200 is not in use, one or more a supercapacitors 108, a subscriber identity module (SIM) 110, an antenna 112, and a switch 114 for toggling between the high throughput modem 104 and the low power modem 106 so that only one of the modems 104, 106 can offload data over a network at a time.

The processor 102 may implement aspects of the present invention with one or more computer programs stored in or on a computer-readable medium, such as memory 114 described below, residing on or accessible by the processor 102. Each computer program preferably comprises an ordered listing of executable instructions for implementing logical functions in the processor. Each computer program can be embodied in any non-transitory computer-readable medium for use by or in connection with an instruction execution system, apparatus, or device, such as a computer-based system, processor-containing system, or other system that can fetch the instructions from the instruction execution system, apparatus, or device, and execute the instructions.

The processor 102 may be multicore or heterogeneous, which provides a first core 116 capable of running a full operating system and a second core 118 having a real-time operating system (OS) to provide deterministic processing of controller area network (CAN), inertial measurement unit (IMU), and input/output (I/O) control. For example, the processor may be an NXP® i.MX8DXL processor, which provides a Cortex-A35 core (first core 116) and a Cortex-M4 core (second core 118). The dual core approach allows for segregation of processes and additional security measures. The importance of a multicore approach or heterogeneous processors is to physically separate responsibilities between the equipment interface (CAN, physical I/Os, etc. running in the MCU in this case and the “connected” interface WiFi, cellular, etc. connections to the application processor core in this case.

The memory 114 may be any computer-readable non-transitory medium that can store programs or applications for use by or in connection with the processor 102. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

The high throughput modem 104 may be a CAT 1, CAT 4, or greater modem for supporting throughput objectives of higher data rate use cases and may be communicatively coupled to the processor 102. The high throughput modem 104 may be used when the remote equipment 200 is in operation and energy consumption is a lessor or minor constraint, thus taking advantage of its speed and bandwidth to allow for offload of real time data. The high throughput modem 104 may be configured to offload data from the remote equipment 200 in a high throughput mode when the remote equipment 200 is in use.

The low power modem 106 (e.g., low-power wide area, LPWA module) supports lower power objectives and use cases for wake on cellular features and may be communicatively coupled to the processor 102. LPWA can be any low power variance such as CAT M1, CAT M2, NB1, or NB2. The low power modem 106 may support 3GPP Rel13 features of extended Discontinuous Reception (eDRX) and Power Saving Mode (PSM). The low power modem 106 can achieve downlink rates of at least 588 Kbps and uplink rates of 119 Kbps. The low power modem 106 may have integrated RAM and flash memory that enables ultra-low power consumption, which may be approximately 85% lower in eDRX current consumption than previous LPWA generations. The low power modem 106 may also be or may also include LTE capabilities (e.g., an LTE LPWA module) that can achieve download rates of at least 42 Mbps and uplink rates of 5.76 Mbps. Such a module may support 4G LTE Category 1 technology with fallback to 3G and 2G networks. The low power modem 106 may be configured to offload data from the remote equipment 200 in a low power mode when the remote equipment 200 is un-powered.

The supercapacitors 108 may provide supplementary or emergency power to the bi-modal cellular telematics control unit 100 to compensate for power outage events, theft events, disconnection events, and the like. Each supercapacitor 108 may be a 20 farad capacitor for example, which may provide approximately 70 to 250 seconds of full run operation while disconnected from equipment battery power. A plurality of supercapacitors 108 may be used to increase operation time for this state.

The SIM 110 may be used between the high throughput modem 104 and the low power modem 106 via a SIM switch/multiplexer. Alternatively, dual SIMs (one for each modem) may be used depending on constraints of the cellular network carrier.

The antenna 112 may be communicatively connected to the high throughput modem 104 and the low power modem 106 via the switch 114. The antenna 112 may be configured to transmit data and receive signals transmitted to the bi-modal cellular telematics control unit 100 over the network.

The switch 114 may be communicatively connected between the antenna 112 and the high throughput modem 104 and between the antenna 112 the low power modem 106 and the processor 102. The switch 114 allows the antenna 112 to be used for both modems and ensures only one of the high throughput modem 104 and low power modem 106 can offload data over the network at a time.

The bi-modal cellular telematics control unit 100 may utilize an embedded software architecture with connectivity and data management portions running within an embedded Linux® operating system (OS). The Linux® environment allows for high flexibility and software development efficiency as many open source and prebuilt packages are readily available. Additionally, Linux® has a networking stack that allows for communicating with many devices and interfaces simultaneously while also allowing bridging of certain interfaces such as Wi-Fi and cellular to create “hotspot” functionality. This is coupled with the use of integrated real time processing cores for more deterministic and secure functions as well as separate low power processors for managing sleep modes. A software ecosystem and software development kit (SDK) of the bi-modal cellular telematics control unit 100 may form a platform to create a variety of secure telematics, connected vehicle and edge processing use cases.

The bi-modal cellular telematics control unit 100 may include a programmatic and/or user-facing data services platform (DSP) 124, which is an interface that allows users to view and manage cellular and satellite connected devices (including the bi-modal cellular telematics control unit 100) and manage data plans. The interface may be accessed via a remote computing device such as a laptop, tablet, cellular phone, or the like (see remote device 218). Through the interface, users can activate, change, and deactivate data plans, and adjust device states and modes (for individual devices, or in bulk).

### Sleep State

The bi-modal cellular telematics control unit 100 may utilize a Low Power Management function that handles transitioning the processor 102 and modems 104, 106 in and out of a Sleep state. This involves modulating certain interfaces and peripherals and negotiating the states with the cores 116, 118 and modems 104, 106 to relay wake-up message and notify reception of wake-up signals. The processor 102 may be configured to perform an action on the remote equipment 200 while in the Sleep state.

The processor 102 may monitor multiple wake-up sources and wake-up triggers/events in real time. The wake-up sources or wake-up triggers/events, and particularly local wakeup prompts, may be the timer/real time clock (RTC), key switch, movement detected by the accelerometer, cellular (e.g. Remote Wakeup), and loss of power (anti-theft/tamper detection). When one of the sources triggers a wake event, the appropriate processing logic is executed to transition the system from the Sleep state to a Run state.

The bi-modal cellular telematics control unit 100 may also have a Switch Power Input, which will act as a digital input for wake conditions. While in the Run state the Switch Power Input will be monitored and used to signal the opportunity to enter the Sleep state to save power.

### Remote Wake-Up

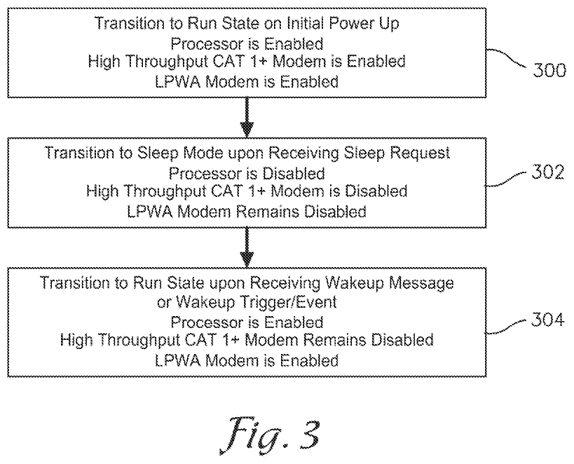

Turning to FIG. 3, transition between the Run state and the Sleep state will now be described in more detail. On initial power up, the bi-modal cellular telematics control unit 100 transitions into the Run state upon the processor 102 receiving, over the network 214, a signal representative of a request to the Run state, as shown in block 300. In this state the processor 102 and MCU are running. The high throughput modem 104 is enabled and connected to the network 214 and the low power modem 106 is powered off.

When sleep is requested from the processor 102, the MCU will wait until the processor 102 sends a command via the communication interface to initiate power state change. At that point the MCU will remove/disable power to the processor 102 and the high throughput modem 104, as shown in block 302.

On receiving a cellular wakeup message on the low power modem 106 or if a movement detection, RTC wakeup, battery disconnection, or CAN wakeup event occurs, the MCU will apply power to the processor 102 and the low power modem 106 and transition to the Run state, as shown in block 304.

The processor 102 may be configured to switch between the high throughput modem 104 and the low power modem 106 so that only one of the high throughput modem 104 and the low power modem 106 can offload data over the network 214 at a time. Many state transition rules and thresholds for switching between Run state and the Sleep state may be implemented in software. This allows for customization and tuning for many vehicles and use cases.

### Remote Wakeup Delivery

Remote wakeup messages can be delivered via a number of mechanisms, which may be determined via several factors such as carrier support. In some cases, several delivery mechanisms can be supported concurrently.

Remote Wakeup via user datagram protocol (UDP) works by delivering a UDP message to the bi-modal cellular telematics control unit 100 while the bi-modal cellular telematics control unit 100 is in eDRX idle. In this mode, the bi-modal cellular telematics control unit 100 maintains an active data session with the network 214 throughout which allows the network 214 to cache and/or store the UDP message until the bi-modal cellular telematics control unit 100 enters its Paging Time Window (PTW). When the bi-modal cellular telematics control unit 100 enters the PTW and the network 214 has a UDP message waiting to be transmitted, the network 214 will page the bi-modal cellular telematics control unit 100 via a paging channel. Once the bi-modal cellular telematics control unit 100 receives the page, the bi-modal cellular telematics control unit 100 will transition to an active state to download the UDP message.

When the bi-modal cellular telematics control unit 100 receives a UDP message, the bi-modal cellular telematics control unit 100 can treat the UDP message as a simple signal (not inspecting contents) or the bi-modal cellular telematics control unit 100 can evaluate the contents for one or more of the following: MAC (Message Authentication Code) or security token to authenticate the request, specific command data or information (e.g. URL) for retrieving additional information.

The UDP delivery may utilize a connection to the network 214 requiring a VPN/IPSEC or other secure connection in order for the Backend 216 to route data to the bi-modal cellular telematics control unit's private IP address. Implementing such an architecture protects the bi-modal cellular telematics control unit 100 from potential spurious wakeups caused by unwanted messages being delivered via a public IP address.

Remote Wakeup via SMS works similarly to UDP wakeup in that the bi-modal cellular telematics control unit 100 will be in eDRX idle waiting for the wake up page. However, SMS delivery does not require the bi-modal cellular telematics control unit 100 to have an active data session to store the wakeup message. SMS has its own caching and delivery policy that is used in this case.

When the bi-modal cellular telematics control unit 100 receives the SMS, the bi-modal cellular telematics control unit 100 can treat the SMS as a simple signal (not inspecting contents) or it can evaluate the contents for one or more of the following: MAC (Message Authentication Code) or security token to authenticate the request, specific command data or information (e.g. URL) for retrieving additional information.

SMS delivery is susceptible to receiving spurious wakeup messages from unwanted parties. With the addition of Message Authentication Code or security tokens this can be reduced but will happen after the bi-modal cellular telematics control unit 100 has been woken up and consumed more energy. SMS can be further protected by restricting the sending party to eliminate some of these issues but may be restricted by the carrier's ability to do so.

### LPWA Modem States

The low power modem 106 may be in one of several states. In an Initializing state, the low power modem 106 is initializing from an Off state. In an Idle state, the low power modem 106 waits for commands. The low power modem's radio is not on and power consumption is minimized. In a Configured state, the application software on the low power modem 106 has issued commands to configure operation of the low power modem 106. In a Registering state, the low power modem 106 searches for a capable network (e.g., network 214) for attachment. Once a capable network is found, the low power modem 106 will attach to the network. In a Connected state, the low power modem 106 is registered/connected to the network. In a Wait for eDRX Unsolicited Result Code (URC) state, the low power modem 106 waits for an eDRX URC to determine if a compatible eDRX setting has been granted by the network. In a Listening for Wakeup state, if UDP wakeup is used, the low power modem 106 creates a Packet Data Protocol (PDP) context and opens a listening UDP socket. If SMS wakeup is used, no-op SMS URC will have been configured during configuration. In a Detaching state, the low power modem 106 is detaching from the network due to invalid eDRX settings or not receiving confirmation of eDRX being granted in a timely fashion. In a Back-off state, the low power modem 106 is sleeping detached from the network with the radio off. The application software on the low power modem 106 will utilize a backoff state machine, which will throttle attempts to reconnect to the network.

### Back-Off State

A Back-off state may be triggered when the bi-modal cellular telematics control unit 100 cannot connect to or becomes disconnected from the network. The Back-off state intelligently controls reconnection attempts and network searching in case of low or no coverage. In other words, the low power modem 106 may throttle network reconnection attempts when the bi-modal cellular telematics control unit 100 is in the low power mode and cannot connect to or becomes disconnected from the network 214. In the Back-off state, the bi-modal cellular telematics control unit 100 may check, among other things, whether network attachments are successful, whether attach timeouts have expired, whether eDRX is received, whether a number of attachment attempts is greater than a threshold, whether poor signal conditions exist, whether a number of disconnections with poor signal conditions is greater than a threshold, and whether a number of attachments with poor signal conditions is greater than a threshold. Backoff may also determine a cause of attachment error. The result of these checks, such as values over threshold, or certain causes of attachment error such as a PLMN error (no data plan) may warrant a long sleep or may warrant waiting for signal conditions to improve.

Non-Supported eDRX/PSM

As LPWA networks (both CAT M1 and NB-IoT) are deployed across the world, some networks may not support all the features that LPWA has to offer. Specifically, power saving features of eDRX and PSM are required for asset trackers and TCUs to conserve battery life and reach the targeted lifetime. By connecting to a network that does not support these features, the devices will consume more power and potentially not achieve their low power use case.

This has been observed in a number of fielded products across various cellular network providers (carriers). For example, one such carrier was found to not support eDRX on its CATM1 network in the US. In order to handle networks that do not support either eDRX or PSM, the following features for handling network selection may be utilized:

When specific eDRX or PSM values are requested from networks that don't support those features, an unsupportive network returns network-provided values that are either “inactive” (in the case of PSM) or “empty” (in the case of eDRX). Furthermore, SIMs support the concept of a “Forbidden” list, which is a list of networks that are stored on the SIM and indicate networks that will not be considered for connection. Normally this list is used when a modem finds a network that is “not allowed” such that it doesn't continue to retry that network, however it can be manually added or cleared through AT commands.

In light of the above, any network that does not support eDRX or PSM (whichever is being used) can be identified and added to a forbidden list on the SIM 108. Specifically, forbidden networks stored on non-volatile memory of the bi-modal cellular telematics control unit 100 may be looked up. These forbidden networks may then be written to the SIM 108 before starting up the low power modem 106. This is required, as the forbidden list is not stored on the SIM 108 across power cycles. The low power modem 106 may then be started up and a network to use may be auto-selected.

Once a successful network connection is made, a power save mode (either eDRX or PSM) can be configured/set. The appropriate modem URCs for the configured mode may be subscribed to. The bi-modal cellular telematics control unit 100 may then wait until the appropriate URC is received or a timer expires. The bi-modal cellular telematics control unit 100 may then query the modem parameters to retrieve information regarding the connection and the requested/provided power save values. The configured power save mode (either eDRX or PSM) being in the “inactive” or “empty” state indicates the current network is not supported.

The current network Mobile Country Code/Mobile Network Code (MCC/MNC) may be appended to the forbidden list. If the forbidden list is full, the bi-modal cellular telematics control unit 100 may remove the oldest network off the forbidden list and append the current network. This immediately takes effect and the low power modem 106 will disconnect from the current network and auto-select from the next best network.

The MCC/MNC of the selected network may be saved to flash memory for use on future connections. In some instances, the forbidden list may only support a small number (e.g., 4) of networks. If there are more unsupportive networks near the bi-modal cellular telematics control unit 100, the bi-modal cellular telematics control unit 100 may reconnect back to an unsupportive network.

### ADDITIONAL CONSIDERATIONS

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Although the present application sets forth a detailed description of numerous different embodiments, the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as the processing system and control systems, may be implemented as special purpose or as general purpose devices. For example, the processing system may comprise dedicated circuitry or logic that is permanently configured, such as an application-specific integrated circuit (ASIC), or indefinitely configured, such as an FPGA, to perform certain operations. The processing system may also comprise programmable logic or circuitry (e.g., as encompassed within a general-purpose processor or other programmable processor) that is temporarily configured by software to perform certain operations. It will be appreciated that the decision to implement the processing system as special purpose, in dedicated and permanently configured circuitry, or as general purpose (e.g., configured by software) may be driven by cost and time considerations.

Accordingly, the terms “processing system” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing system is temporarily configured (e.g., programmed), each of the processing elements need not be configured or instantiated at any one instance in time. For example, where the processing system comprises a general-purpose processor configured using software, the general-purpose processor may be configured as respective different processing elements at different times. Software may accordingly configure the processing system to constitute a hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, later, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims. For example, the principles of the present invention are not limited to the illustrated central pivot irrigation systems but may be implemented in any type of irrigation system including linear move irrigation systems.

Having thus described various embodiments of the invention, what is claimed as new and desired to be protected by Letters Patent includes the following:

1. A bi-modal cellular device installable on remote equipment, the bi-modal cellular device comprising:
a processor configured to receive, over a network, a signal representative of a request to awaken;
a high throughput modem communicatively coupled to the processor and configured to offload data from the remote equipment in a high throughput mode when the remote equipment is in use;
a low power modem communicatively coupled to the processor and configured to offload data from the remote equipment in a low power mode when the remote equipment is un-powered; and
an antenna communicatively coupled to the high throughput modem and the low power modem and configured to transmit the data over the network,
the processor being configured to switch between the high throughput modem and the low power modem so that only one of the high throughput modem and the low power modem can offload data over the network at a time.

2. The bi-modal cellular device of claim 1, wherein the processor is configured to monitor for a remote wakeup prompt and enter a run state upon receiving the remote wakeup prompt, wherein the remote wakeup prompts are in a form of at least one of a user datagram protocol (UDP) message and a short message service (SMS) message.

3. The bi-modal cellular device of claim 1, wherein the processor is configured to monitor for a local wakeup prompt and enter a run state upon receiving the local wakeup prompt, wherein the local wakeup prompt is at least one of a time-based wakeup prompt, a key switch wakeup prompt, an accelerometer wakeup prompt, a CAN wakeup prompt, and a power loss wakeup prompt.

4. The bi-modal cellular device of claim 1, wherein the processor includes first and second cores, at least one of the first and second cores running a real-time operating system configured to provide deterministic processing of CAN, IMU, and I/O control.

5. The bi-modal cellular device of claim 1, wherein the low power modem is configured to enter a backoff state in which the low power modem throttles network reconnection attempts when the bi-modal cellular device is in the low power mode and cannot connect to or becomes disconnected from the network.

6. The bi-modal cellular device of claim 1, further comprising a supercapacitor to provide power to the bi-modal cellular device in case of power outage events, theft events, and disconnection events.

7. The bi-modal cellular device of claim 1, the high throughput modem being a CAT 1, CAT 4, or greater modem.

8. The bi-modal cellular device of claim 1, the low power modem being at least one of a CAT M1, CAT M2, NB1, and NB2 modem.

9. The bi-modal cellular device of claim 1, wherein the low power modem supports 3GPP Rel13 features of extended Discontinuous Reception (eDRX) and Power Saving Mode (PSM).

10. The bi-modal cellular device of claim 1, further comprising a SIM linked to the high throughput modem and the low power modem.

11. The bi-modal cellular device of claim 10, the processor being configured to use at least one of eDRX and PSM, identify whether a potential network does not support at least one of eDRX and PSM, and add the potential network to a forbidden list on the SIM.

12. The bi-modal cellular device of claim 1, the processor being configured to perform an action on the remote equipment while in the low power mode.

13. The bi-modal cellular device of claim 1, wherein the processor is configured to run a data services platform for user management of data plans and cellular and satellite connected devices and for user changes between different modes and states of the bi-modal cellular device.

14. A bi-modal cellular device installable on remote equipment, the bi-modal cellular device comprising:
a processor configured to receive, over a network, a signal representative of a request to awaken;
a high throughput modem communicatively coupled to the processor and configured to offload data from the remote equipment in a high throughput mode when the remote equipment is in use;
a low power modem communicatively coupled to the processor and configured to offload data from the remote equipment in a low power mode when the remote equipment is un-powered;
an antenna communicatively coupled to the high throughput modem and the low power modem and configured to transmit the data over the network; and
a switch connected between the antenna and the high throughput modem and between the antenna and the low power modem so that only one of the high throughput modem and the low power modem can offload data over the network at a time.

15. The bi-modal cellular device of claim 14, wherein the processor is configured to monitor for a remote wakeup prompt and enter a run state upon receiving the remote wakeup prompt, wherein the remote wakeup prompts are in a form of at least one of a UDP message and an SMS message.

16. The bi-modal cellular device of claim 14, wherein the processor is configured to monitor for a local wakeup prompt and enter a run state upon receiving the local wakeup prompt, wherein the local wakeup prompt is at least one of a time-based wakeup prompt, a key switch wakeup prompt, an accelerometer wakeup prompt, a CAN wakeup prompt, and a power loss wakeup prompt.

17. The bi-modal cellular device of claim 14, wherein the processor includes first and second cores, at least one of the first and second cores running a real-time operating system configured to provide deterministic processing of CAN, IMU, and I/O control.

18. The bi-modal cellular device of claim 14, wherein the low power modem is configured to enter a backoff state in which the low power modem throttles network reconnection attempts when the bi-modal cellular device is in the low power mode and cannot connect to or becomes disconnected from the network.

19. The bi-modal cellular device of claim 14, the processor being configured to use at least one of eDRX and PSM, identify whether a potential network does not support at least one of eDRX and PSM, and add the potential network to a forbidden list on the SIM.

20. A bi-modal cellular device installable on remote equipment, the bi-modal cellular device comprising:
a processor configured to use at least one of eDRX and PSM and receive, over a network, a signal representative of a request to awaken, the processor including first and second cores, at least one of the first and second cores running a real-time operating system configured to provide deterministic processing of CAN, IMU, and I/O control;
a high throughput modem communicatively coupled to the processor and configured to offload data from the remote equipment in a high throughput mode when the remote equipment is in use, the high throughput modem being at least a CAT 1 modem;
a low power modem communicatively coupled to the processor and configured to offload data from the remote equipment in a low power mode when the remote equipment is un-powered, the low power modem being at least one of a CAT M1, CAT M2, NB1, and NB2 modem and configured to support eDRX and PDM;
a supercapacitor to provide power to the bi-modal cellular device in case of power outage events, theft events, and disconnection events;
a SIM linked to the high throughput modem and the low power modem;
an antenna communicatively coupled to the high throughput modem and the low power modem and configured to transmit the data over the network; and
a switch connected between the antenna and the high throughput modem and between the antenna and the low power modem so that only one of the high throughput modem and the low power modem can offload data over the network at a time.
